(19) United States
(12) Patent Application Publication
(10) Pub. No.: US 2011/0289451 A1
(43) Pub. Date: Nov. 24, 2011

(54) METHODS AND SYSTEMS FOR CUSTOMIZING USER NOTIFICATIONS

(75) Inventor: Ronald F. Fischer, San Francisco, CA (US)

(73) Assignee: salesforce.com, inc., San Francisco, CA (US)

(21) Appl. No.: 13/110,752

(22) Filed: May 18, 2011

Related U.S. Application Data
(60) Provisional application No. 61/346,836, filed on May 20, 2010.

(51) Int. Cl. G06F 3/048

(52) U.S. Cl. 715/808

(57) ABSTRACT

Methods and systems are provided that aid users in customizing notification graphical user interface (GUI) components. In some aspects, the customization interface is driven from the notification interface or window. Users may then manage the position and appearance of a notification window or GUI component from the notification itself. In addition, the user can manage the position of a notification and direction of subsequent notifications from an originating notification.

### CROSS-REFERENCES TO RELATED APPLICATIONS

This application claims benefit of priority to U.S. Provisional Application 61/346,836, filed May 20, 2010, commonly assigned, which is incorporated in its entirety by reference for all purpose.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

User notifications, or ‘toasters’ are popularly used to display information about an event which occurred during application runtime. Notifications are generally displayed as small rectangular windows, starting in the lower right or upper left corner of the screen, for example. If additional notifications are displayed while older ones are still on-screen, they are often displayed proceeding up or down the height of the screen, respectively. With the proliferation of these notifications there can be conflicts between applications. Notifications can overlap, and it can be difficult to determine from which application a notification originates. Thus, it would be useful to provide mechanisms for a user to customize notifications that allow her to organize them in a way to make them easy to use.

Some solutions have been provided that allow a user to customize user notification windows or systems by navigating through a complex menu from the main application. For example, a user may be required to go to the tools options menu item, and then be required to go to notification options, and advanced settings before being able to provide a notification customization preference. Often users have to search either in the application manual or on the internet for the complicated sequence of steps required to adjust or modify notification settings. Such systems are cumbersome and make a user's task of managing notifications difficult.

What is needed are simpler, user-friendly solutions to aid users in managing their notifications efficiently without complicated instructions.

### BRIEF SUMMARY

The present invention generally relates to user customizations, and more particularly to customization of user notifications for use in an on-demand database and/or application service.

Methods and systems are provided in various embodiments that make a user's task of notification management simpler. In one embodiment, the user may customize notification preferences from the originating notification itself. For example, the user may press a customization icon (e.g. a gear box) that is located on a toaster or other user notification window. A preferences window may then be launched for the user to customize this notification and subsequent notifications. After receiving the user preferences from the preferences user interface, the customization can be applied to attributes of the user notification component and displayed back to the user.

In other embodiments, the user may customize a notification by using certain in-place controls on the notification GUI component. For example, when a user hovers for a certain length of time over a notification, it may lead to activation of certain in-place controls such as directional arrows, durational roller or pin tacks, that then become visible on the notification window. Alternatively, the in-place controls may be visible/active at all times on the user notification, thereby not requiring an indication from the user to customize. In either case, the user can interact with the always visible or activated controls. For example, a user may drag the notification window and use the directional arrows to provide positions for subsequent windows, and then mouse down to complete the customization process. As another example, the user may press down on the pin tack causing the notification to be pinned to the desktop at that location.

In some aspects, the customizations (e.g. the preferences or changes submitted by a user to customize a first notification window) may effect subsequent notifications originating from the same underlying application, from where the first notification window originated. In other aspects, the user customization preferences may be applied to other notification systems for other applications.

In one embodiment, the user customization is persisted for future use either by the current application or others. The persistence can be local to the user's computing device or to a remote database. In various embodiments, the logic for managing user notifications can reside in a main application, in the notification window, or in a separate notification management engine/system.

According to one embodiment, a computer-implemented method is provided for customizing a visual user notification. The method typically includes detecting a customization event, the customization event expressing a user's interest in customizing a visual user notification, and providing a mechanism for the user to submit a user customization preference responsive to detecting the customization event. The method also typically includes receiving the user customization preference submitted by the user, and customizing an attribute of the user notification based on the user customization preference. Typically the visual user notification is displayed as part of a graphical user interface on a display device coupled with a processor implementing the method. In certain aspects, the method further includes displaying the customized visual user notification, e.g., on the display device. In certain aspects, types of user customization preferences for visual user notification systems include attributes such as duration of the notification, location of the notification, coloring schemes for the notification, size of the notification, ability to pin the notification to the desktop, or placement of subsequent notifications. In certain aspects, the method further includes persisting the customized user visual notification and/or the user customization preference either locally, or remotely (e.g., to a remote database).

According to another embodiment, a notification system is provided that typically includes a display device and a processor communicably coupled with the display device. The processor is typically configured to detect a customization event, the customization event expressing a user's interest in customizing a visual user notification, wherein the customization event originates from the user notification that the user wants to customize, and to provide a mechanism for the user to submit a user customization preference responsive to detecting the customization event. The processor is further typically configured to receive the user customization preference submitted by the user, to customize an attribute of the user visual notification window based on the user customization preference, and to display the user notification on the display device. In certain aspects, the notification window is interactive, whereby the user receiving the notification is able to send messages back to the application from which the notification originated.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an environment wherein an on-demand database service might be used.

FIG. 2 illustrates a block diagram of an embodiment of elements of FIG. 1 and various possible interconnections between these elements according to an embodiment of the present invention.

FIG. 3 illustrates one embodiment of a notification system, where notifications stack on top of each other in a diagonal direction.

FIG. 4 illustrates a block diagram of an embodiment of the steps taken for user customization of notifications.

FIG. 5 illustrates one embodiment of a notification with a customization icon, and a notification with several in-place controls.

FIG. 6 illustrates one embodiment of a user notification management system.

### DETAILED DESCRIPTION

The present invention provides systems and methods for user customizations, and more particularly to customization of user notifications and positioning control of user notifications.

As used herein, the term multi-tenant database system refers to those systems in which various elements of hardware and software of the database system may be shared by one or more customers. For example, a given application server (e.g. running an application process) may simultaneously process requests for a great number of customers, and a given database table may store rows for a potentially much greater number of customers. As used herein, the term query or query plan refers to a set of steps used to access information in a database system.

### System Overview

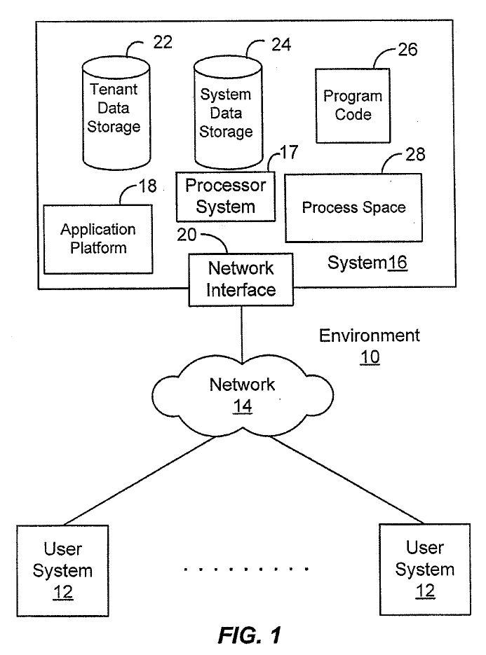

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

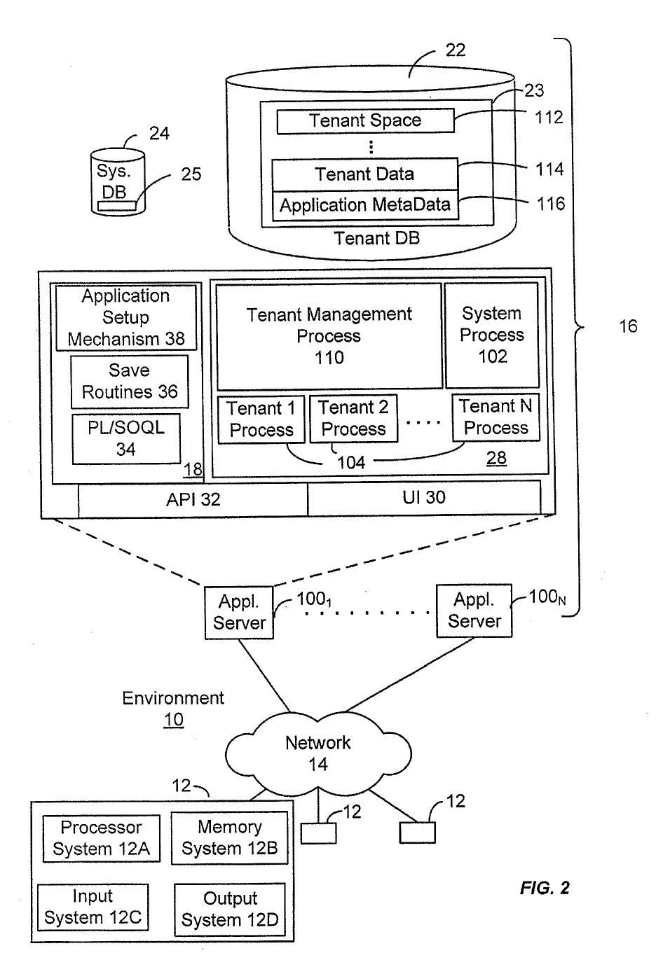

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. Yet another table or object might describe an Opportunity, including fields such as organization, period, forecast type, user, territory, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system.

### Customization of User Notifications

Graphical user interface (GUI) notification components (e.g. notifications, toasters, alerts, windows etc.) are popularly used to display information about an event which occurred when an application for example is not in the foreground on a user interface (UI). Notifications are generally displayed as small rectangular windows, starting in the lower right or upper left corner of the screen, for example. They can be interactive, allowing a user to respond back to the application from which it originated, often acting on the information that the alert or notification provided.

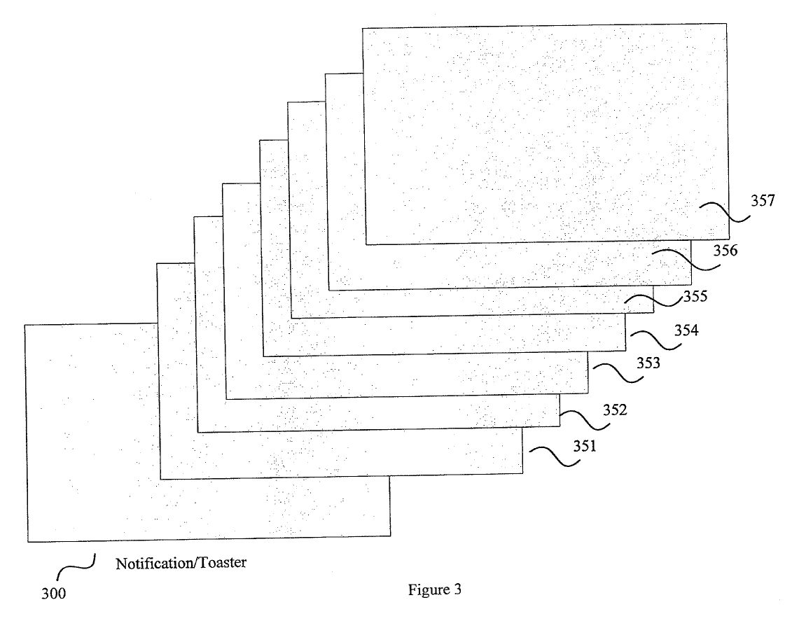

If additional notifications are displayed while older ones are still on-screen, they are often displayed proceeding up or down the height of the screen, respectively. Sometimes these notifications are tiled in a diagonal direction relative to the first notification. FIG. 3.0 is an illustration of notification windows stacking on top of each other, diagonally. In it, window 300 represents an originating first notification, while windows 351-357 represent the subsequent tiled notifications.

With the proliferation (e.g. with notifications as illustrated in FIG. 3 arising from a multitude of user applications, running at the same time) of these notifications there can be conflicts between applications. Notifications can overlap, and it can be difficult to determine from which application a notification originates. This can lead to user confusion, thereby leading to either missed information or missed actions that may be important to the user.

In certain embodiments, user systems 12 (which may be client systems) of FIG. 1 provide customization abilities for user notifications. Some embodiments of the present invention provide users with simpler ways to control, organize, and customize the appearance and location of notifications on the screen, and provide positional and other preferences for subsequent notifications to be displayed. In one embodiment, the user can advantageously submit customization preferences or requests, from the originating user notification visual component as opposed to say from the main application (i.e. the main application in this context being the application which sends a user notification to the user interface). The ability for a user to customize notifications from a notification itself, for example from the toaster or pop-up notification window, greatly eases the task of notification management. Alternate systems, where the user must navigate through menu options of the main application in order to organize the associated notifications, complicate the user's experience with an application and the management of associated notifications.

In one embodiment, a user's desire to customize a user notification is detected. For example, when a user hovers over the notification window for a certain period of time or when the user executes a “mouse down” event on the notification window or by clicking a customization icon on the notification GUI (e.g. a gear box icon for customization). Other mechanisms by which a user may communicate desire to customize a window include: the user double clicking on the window or sub-component of the window or the user touching or gesturing (e.g. on a touch system such as an Android tablet). Upon the detection of a user's desire to customize the notification GUI component, the user is provided a mechanism by which to customize the preferences for the notification system, the preferences are then applied to the notification window and/or system. In one embodiment, the preferences may impact subsequent notifications, as to its appearance and/or location. In another embodiment, the preferences are applied to the current notification window, as well as subsequent notifications.

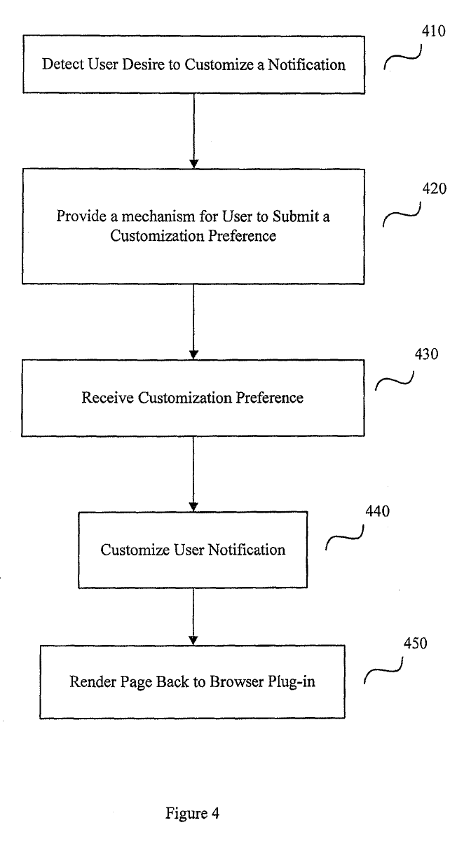

FIG. 4 illustrates one embodiment of a method for customizing user notifications. The steps of the method may be implemented in a user notification management system. The system in step 410 detects a user desire to customize a notification GUI or window. Upon such detection of user desire to customize a window, in step 420 a mechanism for the user to submit the user preference will be provided to the user. In step 430 the system will receive the user preference for customization which is then applied in step 440. And the customized user notification is then displayed back to the user in step 450. One skilled in the art can appreciate various ways the preferences may be applied to user notifications. For example, a user preference may be applied to the originating notification window, subsequent windows, both, or neither (e.g. the preferences will impact the system only when application is restarted).

In one embodiment, the mechanism provided to the user for submitting preferences in step 320 includes a preference management GUI or window. This component or preferences window is launched upon the detection of user desire to customize notifications (e.g. when the user clicks on a “gear box” icon). The user then may choose from various customization tabs and options in order to specify the customizations she desires. The preferences window may launch other windows upon user selection of options and preferences.

In other embodiments, the mechanism provided to a user for customizing a notification may include various in-place controls (i.e. those that are present on the notification window itself) to quickly customize a particular preference. In one embodiment, the in-place controls are visible and active for user instructions on notifications windows as they pop-up on the user screen. In other embodiments, the in-place controls become activated upon detection of user desire to customize a window. For example, when a user hovers over a notification for a certain amount of time, the controls on that notification window can be activated and thereby become visible for the user to interact with to provide customization preferences.

As some examples of in-place controls, directional arrows (for providing location of subsequent toasters or notifications), a thumb tack icon (for pinning the notification to the desktop), a roller for modifying the duration of a notification, color selector palette, volume control for associated sound, transparency slider, font size control, maximum notification count, etc. may show up in response to detecting user desire to customize a window or may be present on notification windows in general (i.e. without requiring detection of use desire to customize). Using these in-place controls, the user can provide customization preferences implemented by that control.

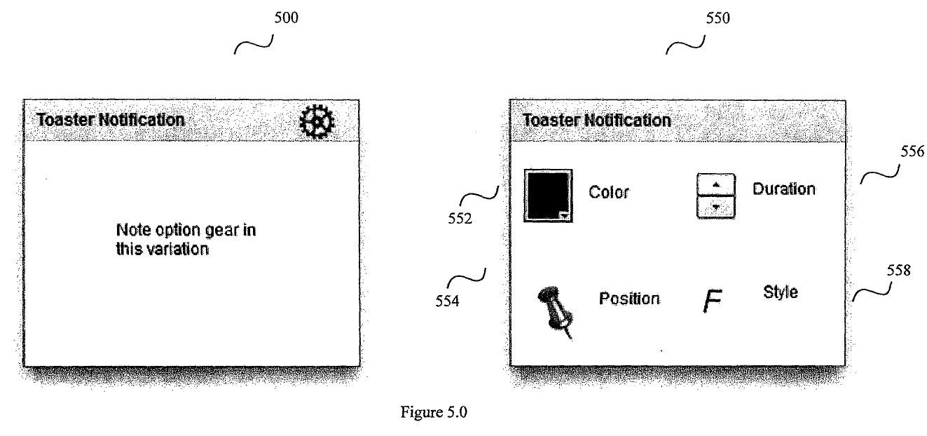

FIG. 5.0 illustrates one embodiment of a notification GUI window with an icon for customization and another GUI window with in-place controls. Item 500 illustrates a toaster style notification with a gear icon, indicating that options are available for modifying the properties or attributes of the notification window. Other suitable visual cues may be used instead of a gear icon for providing customizations. The pressing of the gear icon may then launch another preferences/customization window by which the user can provide her preferences. In some aspects, the preferences window may contain various folder tabs or may launch other sub-windows for further customizations.

Item 550 of FIG. 5.0 illustrates a toaster notification with several in-place editing options: control 552 for modifying the color scheme of the window, control 554 for positioning the notification, control 556 for providing the duration of the notification, and control 558 for customizing the font style properties of the window.

Other possible in-place controls include but are not limited to: background color, font color, title bar color, flashing properties (on/off, duration), associated alert sound/volume, fount size and style, duration of the display, starting position on the screen, direction for display of additional notifications, size of the notification, transparency (alpha) of the notification, and maximum number of notifications to display at one time. Alternatively, these properties can be modified on a separate customization window, launched from a customization icon or menu item (e.g. launched by pressing the gear icon described above). They may also be customizable, both via in-place controls and separate customization windows.

In one example of in-place controls, the user may drag the notification window and use the directional arrows to provide positions for subsequent windows, and then mouse down to complete the customization process.

According to one embodiment:
1) Initially a default position/direction combination is specified for notifications.
2) Once a notification is shown, a user may ‘mouse down’ over the notification to indicate that a new starting position is desired, by pressing a mouse button.
3) Once the ‘mouse down’ is detected the notification will be decorated with a visual indication of ‘move mode’, and may be dragged to any valid location on the screen.
4) Once the notification is at the desired location the user then releases the mouse button, causing a ‘mouse up’.
5) The ‘move mode’ decorations are removed and directional arrows are shown for any valid compass directions (e.g. directions that do not immediately hit the side of the screen).
6) The user may select the compass direction to indicate in which direction additional notifications should occur.
7) At this point in time all new notifications will be placed at the new starting location.
8) All notifications which occur while one is still showing follow the direction indicated by the user.
9) All user settings are persisted so that they can be used whenever the application runs.

According to alternate embodiments, a mouse hover period (where the mouse hovers over a notification) is used to initiate the ‘move mode’, rather than a ‘mouse down’. In this case, after a certain amount of hover time, a drag decoration would be displayed on the notification. Then a gesture is used to determine the direction of additional notifications. The default direction is determined automatically.

In one embodiment, the mechanism provided to a user for submitting customizations or preferences may include a combination of in-place controls and launched preferences window. For example, a user may specify the direction and position via in-place controls and then click on a “gear box” icon to provide further customization details. The pressed “gear box” icon then may launch one or more preferences windows to allow for further customizations (e.g. colors and size of notifications). In another example, the user may press down on one of the activated in-place controls, which then may lead to the launching of a preferences sub-window that allows the user to provide more details about preferences for notifications.

In some embodiments, the types of customization preferences a user can provide include: starting position of a notification visual component, the direction for subsequent notifications, the size of the notification component, color schemes of the component, duration of the notification window, and ability to pin the notification to the desktop or other user computing device. These preferences may be customizable via either a preferences window GUI or via in-place controls or both.

In one embodiment, the user can apply preferences chosen for one notification system to another notification system. This functionality may be provided where the user preferences are persisted for a notification system. In one embodiment, the user notification preference or the customized notification is persisted locally, for example, in an XML file or a local database on the user's desktop or other computing device. In other embodiments, they can be persisted or stored on a remote system (e.g. a remote database on the cloud). In some embodiments, the remote preferences can be used to synchronize with a user computing device upon the launching of an application with the associated notifications.

In one embodiment, the programming logic for the user customization system described herein exists in the main application associated with the notifications. In such a system the code implementing the main application also has code for customization of user notification preferences. So for example, when a user installs a full application on his computing device, it may contain programming logic that tracks user desire to customize a notification that originates from this application and then provides mechanisms for customizations, thus, allowing customization of notifications of the application containing such logic. In another embodiment, the logic for notification customization may exist in the notification window itself.

In yet other embodiments, the programming logic for managing user notification preferences or customizations may be housed in a separate application (e.g. in a customization engine). For example, a customization engine application may be running either locally or remotely from the user's computing device and independent of the application from which the notifications originate. Such an application, for example may implement an event listener that listens for user interaction events (e.g. via the mouse or keypad or otherwise) and act upon the receiving of such an event. In some aspects, an independent customization engine system may allow for user notification customizations for a multitude of applications, thus decoupling notification management from the application from which the notifications originate. In some embodiments, applications may code to the API of such an event listener in order to provide customization capabilities of the event listener to the application. In other embodiments, the stand-alone application may listen for hardware component events or operating system level commands (e.g. mouse down, etc.) and interpret them in order to provide customization capabilities.

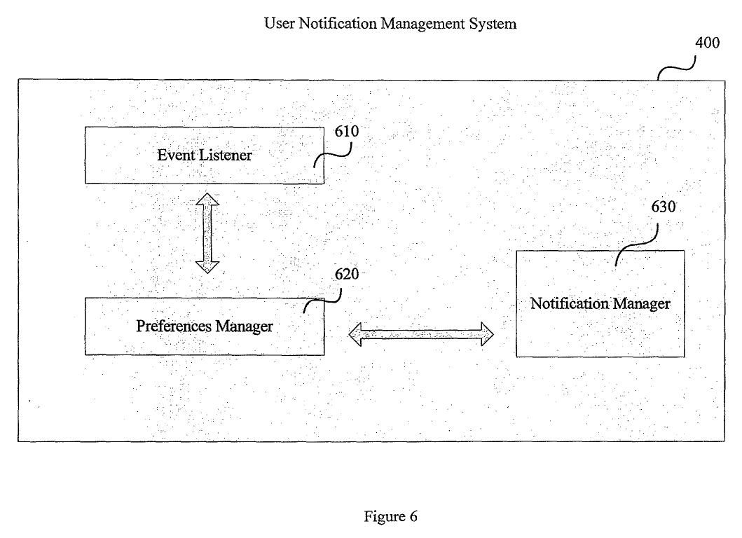

FIG. 6 illustrates one embodiment of a user notification management system, 600. System 600 includes an event listener module 610, a preferences management module 620 and a notification management module 620. Event listener module 610 may for example listen for events that indicate user desire to customize a notification. This may include an event such as hovering or mouse down on a particular customization icon. Alternatively, it may include listening for certain API calls specific to the notification management system 600. Event listener module 610 may then pass control to preferences management module 620, upon receiving a customization type of event. The preferences management module 620 then may either launch a preferences window, or activate certain in-place controls on the notification window or both. The preferences management module 620 may also then receive the customization requests from the user and pass them over to the notification management module 630. Notification management module 630 then may apply the customization request to the notification window, save the preferences for future use by this system or others, and otherwise use the preferences' information in various ways to manage user notifications. Such a system may be implemented in the main application or in a stand-alone preferences management application.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method for customizing a visual user notification comprising:
detecting a customization event, the customization event expressing a user's interest in customizing a visual user notification;
providing a mechanism for the user to submit a user customization preference responsive to detecting the customization event;
receiving the user customization preference submitted by the user; and
customizing an attribute of the user notification based on the user customization preference.

2. The method of claim 1 wherein the customization event originates from the visual user notification that the user wants to customize.

3. The method in claim 1 wherein types of user customization preferences for visual user notification systems include attributes such as duration of the notification, location of the notification, coloring schemes for the notification, size of the notification, ability to pin the notification to the desktop, or placement of subsequent notifications.

4. The method of claim 1 further comprising:
persisting the customized user visual notification either locally or remotely.

5. The method of claim 1 further comprising:
persisting the user customization preference either locally or remotely.

6. The method of claim 5 further comprising:
customizing the attribute of a second user notification based on the persisted user customization preference.

7. The method of claim 1 wherein logic for customizing the user visual notification resides in the user notification.

8. The method of claim 1 wherein logic for customizing the user visual notification resides in a main application that the user notification originated from.

9. The method of claim 1 wherein logic for customizing the user visual notification resides in a customization engine, independent of the notification or the main application from which the user notification originated.

10. The method of claim 1 wherein the customization event is detected by the hovering of the mouse over the notification or by the user clicking a customization icon on the notification.

11. The method in claim 1 wherein a customization window is launched in the step of providing a mechanism for the user to submit a user customization request.

12. The method in claim 1 wherein in-place controls are activated in the step of providing a mechanism for the user to submit a user customization request.

13. The method in claim 1 wherein the providing of a mechanism for the user to submit a user customization request, is achieved by the pre-existing in-place controls visible on the user visual notification.

14. A notification system for customizing a visual user notification, the system comprising:
a display device; and
a processor configured to:
detect a customization event, the customization event expressing a user's interest in customizing a visual user notification, wherein the customization event originates from the user notification that the user wants to customize;
provide a mechanism for the user to submit a user customization preference responsive to detecting the customization event;
receive the user customization preference submitted by the user;
customize an attribute of the user visual notification window based on the user customization preference; and
display the user notification on the display device.

15. The notification system of claim 14 wherein the notification window is interactive, whereby the user receiving the notification can send messages back to the application from which the notification originated.

16. The method of claim 1, further including displaying the customized visual user notification back to the user.
